(19) United States
(12) Patent Application Publication
(10) Pub. No.: US 2011/0091804 A1
(43) Pub. Date: Apr. 21, 2011

(54) Copper Phthalocyanine Pigment Preparation

(75) Inventors: Josef Geisenberger, Sulzbach (DE); Hans-Tobias Macholdt, Darmstadt-Eberstadt (DE); Thomas Metz, Heppenheim (DE); Steffen Schneider, Frankfurt am Main (DE); Christian Zeh, Eltville (DE)

(73) Assignee: CLARIANT FINANCE (BVI) LIMITED, Tortola (VG)

(21) Appl. No.: 12/994,257

(22) PCT Filed: May 2, 2009
(86) PCT No.: PCT/EP09/03170

§ 371 Date: Jan. 4, 2011

(30) Foreign Application Priority Data
Jun. 3, 2008 (DE) 10 2008 026 584.5

(51) Int. Cl. G03G 9/09; C04B 16/00; G02F 1/361; C09D 11/02

(52) U.S. Cl. 430/108.21; 106/480; 252/582; 106/31.77

(57) ABSTRACT

The invention relates to a pigment preparation, comprising (a) pigmentary copper phthalocyanine of the beta phase, characterized by a mean particle size d₅₀ of 40 to 80 nm and a mean length to width ratio of the pigment particles of less than or equal to 2.0:1, and (b) 1% to 30% by weight, relative to the weight of the pigmentary copper phthalocyanine, of a pigment dispersant of the formula (II)

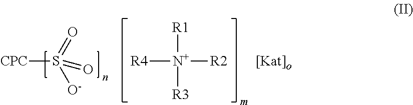

where CPC is a group of a copper phthalocyanine, n is a number from 1 to 4.0, m is a number from 0.5 to 4.0; Kat is a cation from the group of the alkali metals, or H⁺; o is a number from 0 to 3.5, with n=m+o; R¹, R², R³, R⁴ are the same or different and are C₁-C₂₀ alkyl, C₂-C₂₀ alkenyl, C₅-C₂₀ cycloalkyl, C₅-C₂₀ cycloalkenyl or C₁-C₄ alkyl-phenyl, wherein the above groups are optionally substituted by hydroxyl and/or halogen. The pigment preparation is characterized by extreme high viscosity stability, which makes it particularly suitable for aqueous, solvent based and UV-curing inkjet inks.

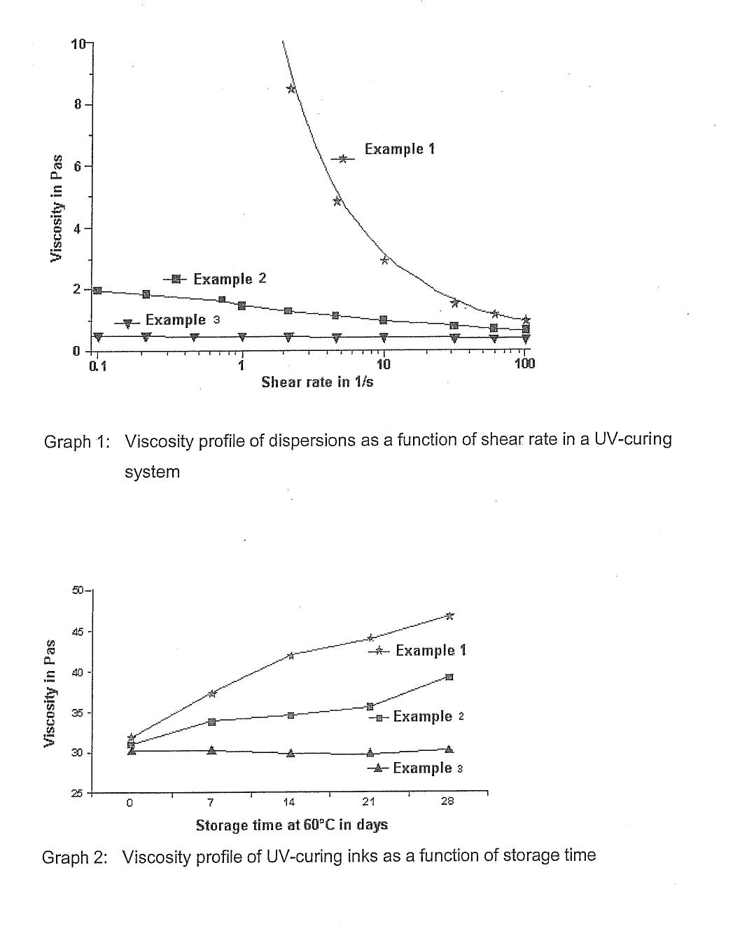

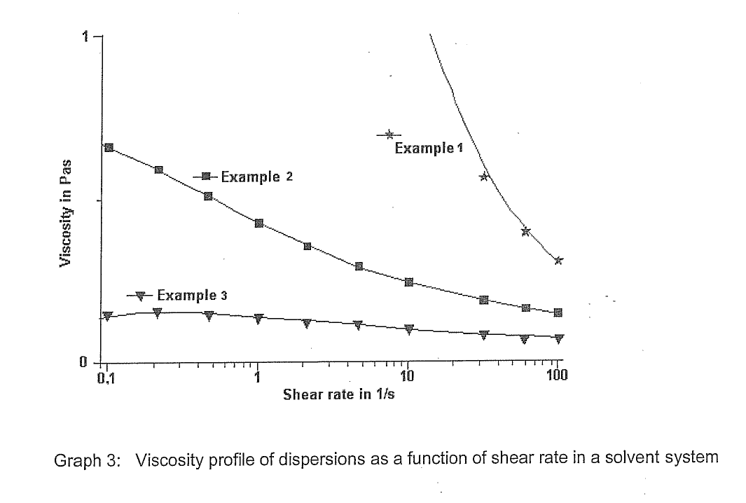

The present invention relates to an improved cyan colorant for inkjet inks, more particularly for solvent- and UV-curing inkjet inks.

Pigments are increasingly being used as colorants for inkjet inks. Pigments have the advantage over the soluble dyes that they are present in the form of small particulate solids in dispersion in the ink and so have significantly better light fastnesses, solvent stabilities and temperature stabilities.

In particular, cyan colorants based on beta-copper phthalocyanine pigments (C.I. Pigment Blue 15:3 and 15:4) exhibit among the best light, solvent and temperature stabilities and are therefore the most frequently used cyan colorants. In view of the ever more rapid inkjet printing processes, the increasingly small droplet size, and the heightened quality requirements imposed on the inkjet inks, there is a need for improved copper phthalocyanine pigment preparations.

One particularly important aspect is the improvement in fluidity and sprayability of the inks. A key parameter for this is the stability of the ink viscosity. The viscosity is not only to have a very low value but is also to be independent of the shear rate. It is important, furthermore, that this viscosity remains the same even after a prolonged ink storage time, in which context it is especially important that it be insensitive to fluctuations in temperature. Only then is it guaranteed that an ink will be printable with the same quality even after a prolonged storage time.

It is known that copper phthalocyanine pigments in particular have a great influence on ink stability. Corresponding aging test methods therefore measure the viscosity stability of inks based on Pigment Blue 15 after a one-week storage time at a temperature of 40° C. or higher.

WO 2004/052997 describes phthalocyanine pigment preparations for printing inks but they do not attain the viscosity stability required of inkjet inks.

EP 1 073 695 A discloses phthalocyanine pigment preparations for oil-based printing inks and gravure printing inks, which likewise fail to meet the high profile of requirements for inkjet inks.

For innovative ink systems, the existing cyan pigments are no longer able adequately to meet the heightened requirements concerning ink stability. A search is therefore on for cyan pigments based on Pigment Blue 15 which exhibit not only a viscosity stability across the various shear rates but also, in particular, a low viscosity at very slow shear rates and also after a prolonged storage time of the ink at elevated temperatures.

Surprisingly, it has now emerged that a beta-copper phthalocyanine pigment preparation featuring a particle morphology with an average length-to-width ratio of less than or equal to 2.0:1, preferably of 1.6:1 to 1.9:1, and a primary particle size distribution of ≦80 nm as the d₅₀ value, preferably of 60 nm to 75 nm as d₅₀ value, and a surface charge of −2.5 to −3.5 C/g possesses a significantly improved viscosity and viscosity stability, more particularly in both solvent-based inks and UV-curing inks.

What is new and surprising is that the pigment preparation of the invention, in comparison to other copper phthalocyanine preparations which possess a comparable particle size distribution but not the same surface charge, or in comparison to copper phthalocyanine preparations which, although possessing the same surface charge, do not possess a comparable primary particle size and morphology, exhibit a significantly poorer viscosity at different shear rates, and a poorer viscosity stability. Only the combination of the above-stated surface charge, pigment size and pigment morphology yields the improved property in application. It has been found that the specific pigment additive of the formula (II) below endows the copper phthalocyanine pigment with the desired surface charge.

The invention accordingly provides a pigment preparation comprising

(a) pigmentary, beta-phase copper phthalocyanine characterized by an average particle size d₅₀ of 40 to 80 nm, preferably 50 to 75 nm, and an average pigment particle length-to-width ratio of less than or equal to 2.0:1, preferably 1.6:1 to 1.9:1, and

(b) 1% to 30% by weight, preferably 5% to 20% by weight, based on the weight of the pigmentary copper phthalocyanine, of a pigment dispersant of the formula (II)

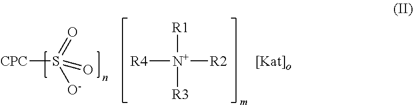

where

CPC is a radical of a copper phthalocyanine,

n is a number from 1 to 4.0, preferably 1 to 2.0;

m is a number from 0.5 to 4.0, preferably 0.7 to 2.0;

Kat is a cation from the group of the alkali metals, such as Li, Na, K; or H⁺;

o is a number from 0 to 3.5, with n=m+o;

R¹, R², R³, and R⁴ are identical or different and are C₁-C₂₀ alkyl, C₂-C₂₀ alkenyl, C₅-C₂₀ cycloalkyl, C₅-C₂₀ cycloalkenyl or C₁-C₄ alkyl-phenyl, the aforesaid radicals being optionally substituted by hydroxyl and/or halogen.

By pigmentary beta-phase copper phthalocyanine is meant more particularly C.I. Pigment Blue 15:3 and 15:4.

The radical CPC is preferably a radical of the formula (I)

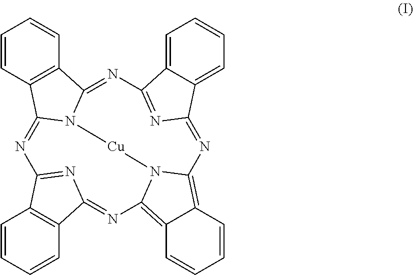

In one preferred embodiment of the invention the radicals

R¹, R², and R³ are C₁-C₄ alkyl, and

R⁴ is C₁₂-C₂₀ alkyl, C₁₂-C₂₀ alkenyl, C₆-C₂₀ cycloalkyl, C₆-C₂₀ cycloalkenyl or benzyl, the aforesaid radicals being optionally substituted by hydroxyl and/or halogen, such as F, Cl, or Br, more particularly F or Cl.

In a further preferred embodiment the radicals

R¹ and R² are C₁-C₄ alkyl, and

R³ and R⁴ are C₆-C₂₀ alkyl, C₆-C₂₀ alkenyl, C₆-C₂₀ cycloalkyl, C₆-C₂₀ cycloalkenyl or benzyl, the aforesaid radicals being optionally substituted by hydroxyl and/or halogen, such as F, Cl, or Br, more particularly F or Cl.

In one particularly preferred embodiment the radicals

R¹, R², and R³ are methyl, and

R⁴ is C₁₄-C₂₀ alkyl or C₁₄-C₂₀ alkenyl.

In another particularly preferred embodiment the radicals

R¹ and R² are methyl, and

R³ and R⁴ are benzyl, C₈-C₂₀ alkyl or C₈-C₂₀ alkenyl.

Examples of preferred radicals N⁺R¹R²R³R⁴ are trimethylhexyl-, trimethyloctyl-, trimethyldecyl-, trimethylcetyl-, trimethyllauryl-, trimethylstearyl-, distearyldimethyl-, dimethylstearylbenzyl-ammonium.

The invention also provides a method of producing the pigment preparation of the invention, which comprises subjecting a crude copper phthalocyanine pigment to salt kneading with a crystalline inorganic salt in the presence of an organic solvent, and, before, during and/or after the salt kneading, adding a pigment dispersant of the formula (II).

Suitable crystalline inorganic salt is, for example, aluminum sulfate, sodium sulfate, calcium chloride, potassium chloride or sodium chloride, preferably sodium sulfate, sodium chloride and potassium chloride.

Suitable organic solvent is, for example, ketones, esters, amides, sulfones, sulfoxides, nitro compounds, mono-, bis- or tris-hydroxy-C₂-C₁₂ alkanes, which may be substituted by C₁-C₈ alkyl and one or more hydroxyl groups. Particularly preferred are water-miscible, high-boiling organic solvents based on monomeric, oligomeric and polymeric C₂-C₃ alkylene glycols, such as diethylene glycol, diethylene glycol monomethyl and ethyl ether, triethylene glycol, triethylene glycol monomethyl and ethyl ether, dipropylene glycol, dipropylene glycol monomethyl and ethyl ether, propylene glycol monomethyl and ethyl ether, and liquid polyethylene glycols and polypropylene glycols, N-methylpyrrolidone, and also triacetin, dimethylformamide, dimethylacetamide, ethyl methyl ketone, cyclohexanone, diacetone alcohol, butyl acetate, nitromethane, dimethyl sulfoxide and sulfolane.

The weight ratio between the inorganic salt and the copper phthalocyanine is preferably (2 to 8):1, more particularly (5 to 7):1.

The weight ratio between the organic solvent and the inorganic salt is preferably (1 m1:6 g) to (3 m1:7 g).

The weight ratio between the organic solvent and the sum of inorganic salt and copper phthalocyanine is preferably (1 m1:2.5 g) to (1 m1:7.5 g).

The temperature during kneading may be between 40 and 140° C., preferably 80 to 120° C. The kneading time is advantageously 4 h to 12 h, preferably 6 h to 8 h.

Following salt kneading, the inorganic salt and the organic solvent are removed, advantageously by washing with water, and the resulting pigment composition is dried by customary methods.

The salt kneading may be followed by a solvent treatment. The solvent treatment may take place in water or in an organic solvent. Where an organic solvent is used, it may be preferably from the group of alcohols having 1 to 10 carbon atoms, such as, for example, methanol, ethanol, n-propanol, isopropanol, butanols, such as n-butanol, isobutanol, tert-butanol, pentanols, such as n-pentanol, 2-methyl-2-butanol, hexanols, such as 2-methyl-2-pentanol, 3-methyl-3-pentanol, 2-methyl-2-hexanol, 3-ethyl-3-pentanol, octanols, such as 2,4,4-trimethyl-2-pentanol, cyclohexanol; or glycols, such as ethylene glycol, diethylene glycol, propylene glycol, dipropylene glycol, sorbitol or glycerol; polyglycols, such as polyethylene glycols or polypropylene glycols; ethers, such as methyl isobutyl ether, tetrahydrofuran, dimethoxyethane or dioxane; glycol ethers, such as monoalkyl ethers of ethylene glycol or propylene glycol or diethylene glycol monoalkyl ethers, where alkyl may be methyl, ethyl, propyl, and butyl, examples being butyl glycols or methoxybutanol; polyethylene glycol monomethyl ethers, especially those having an average molar mass of 350 to 550 g/mol, and polyethylene glycol dimethyl ethers, especially those having an average molar mass of 250 to 500 g/mol; ketones, such as acetone, diethyl ketone, methyl isobutyl ketone, methyl ethyl ketone, methyl isobutyl ketone or cyclohexanone; a mono-, bis- or tris-hydroxy-C₂-C₁₂ alkane compound which contains 1 or 2 keto groups and in which one or more hydroxyl groups may have been etherified with a C₁-C₈ alkyl radical or esterified with a C₁-C₈ alkylcarbonyl radical; aliphatic acid amides, such as dimethylformamide; or cyclic carboxamides, such as N-methylpyrrolidone, or aromatic hydrocarbons, such as benzene or alkyl-, alkoxy-, nitro-, cyano-, or halogen-substituted benzene, examples being toluene, xylenes, mesitylene, ethylbenzene, anisol, nitrobenzene, chlorobenzene, dichlorobenzenes, trichlorobenzenes, benzonitrile or bromobenzene; or other substituted aromatics, such as phenols, cresols, nitrophenols, such as, for example, o-nitrophenol, and also mixtures of these organic solvents.

Preferred solvents are C₁-C₆ alcohols, more particularly methanol, ethanol, n- and isopropanol, isobutanol, n- and tert-butanol and tert-amyl alcohol; C₃-C₆ ketones, more particularly acetone, methyl ethyl ketone or diethyl ketone; tetrahydrofuran, dioxane, ethylene glycol, diethylene glycol or ethylene glycol C₃-C₅ alkyl ethers, more particularly 2-methoxyethanol, 2-ethoxyethanol, butylglycol, toluene, xylene, ethylbenzene, chlorobenzene, o-dichlorobenzene, nitrobenzene, cyclohexane, diacetone alcohol or methylcyclohexane.

The solvent may also comprise water, acids or alkalis.

With particular preference the solvent treatment takes place in water.

The solvent treatment is carried out advantageously for 1 to 8 h and at a temperature between 30 and 200° C., preferably 60 to 100° C.

The dispersant of the formula (II) may be added before and/or during the salt kneading and/or before and/or during the solvent treatment, in one or more portions, to the copper phthalocyanine pigment.

The dispersant of the formula (II) itself may be prepared by salt formation from the copper phthalocyanine-sulfonic acid of the formula (III)

CPC-(SO₃⁻)ₙ [Kat]ₒ⁺ (III)

in which CPC, Kat, n and o have the definitions stated above, and also from an ammonium compound of the formula (IV)

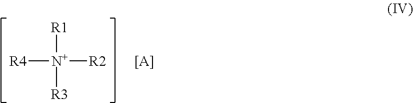

in which R¹, R², R³ and R⁴ have the definitions stated above, and A has the definition Cl⁻, Br⁻, OH⁻, acetate or formate.

It is also possible to prepare the pigment dispersant of the formula (II) in situ, by, for example, separately adding sulfonic acid (salt) of the formula (III) and ammonium salt of the formula (IV) before and/or during the salt kneading or before and/or during the solvent treatment.

Besides the copper phthalocyanine pigment and the additive of the formula (II), the pigment preparation of the invention may further comprise other, customary auxiliaries or adjuvants, such as, for example, surfactants, non-pigmentary dispersants, fillers, standardizers, resins, waxes, defoamers, anti-dust agents, extenders, antistats, preservatives, drying retardants, rheology control additives, wetting agents, antioxidants, UV absorbers, shading colorants, and light stabilizers, preferably in an amount of 0.1% to 25% by weight, more particularly 0.5% to 15% by weight, based on the total weight of the pigment preparation.

The pigment preparations of the invention exhibit significant improvements over conventional pigments based on Pigment Blue 15, particularly in the context of their use in aqueous, UV-curing, and solvent-based inks.

In these contexts it is found that, first, a significantly better viscosity stability relative to existing pigments based on Pigment Blue 15 was achieved and, second, a lower initial viscosity was realizable. These parameters critically influence the flow properties of the ink, the possible drop size, and hence both resolution and printing speed.

It has been found, furthermore, that when the ink is aged, these parameters will also be subject to significantly lower fluctuation than in inks based on conventional Blue 15 pigments.

This property was confirmed even after storage of the inks for 28 days at 60° C., in other words under conditions which are in fact significantly harsher than in the standard test (40° C., 1 week).

The pigment preparations of the invention are especially suitable for producing cyan recording liquids. These liquids may operate on the basis of aqueous or non-aqueous inkjet printing methods and also on the basis of microemulsions, by the hotmelt method, or else for other reproduction, writing, drawing, marking, stamping, recording or printing methods, and also for electrophotographic toners and developers, and for color filters.

The completed recording liquids generally contain a total of 0.1% to 50% by weight of the pigment preparation of the invention, 0% to 99% by weight of water and 0.5% to 99.5% by weight of organic solvent and/or humectants. In one preferred embodiment the recording liquids contain 0.5% to 15% by weight of pigment preparation, 35% to 75% by weight of water and 10% to 50% by weight of organic solvent and/or humectants; in another preferred embodiment they contain 0.5% to 15% by weight of pigment preparation, 0% to 20% by weight of water and 70% to 99.5% by weight of organic solvent and/or humectants.

The recording liquids of the invention may further comprise customary adjuvants as well, examples being preservatives, cationic, anionic or nonionic surface-active substances (surfactants and wetting agents), and also agents for regulating the viscosity, e.g. polyvinyl alcohol, cellulose derivatives or water-soluble natural or synthetic resins as film formers and/or binders for increasing the strength of adhesion and the abrasion resistance.

The pigment preparations of the invention and also the inkjet inks produced from them may also be shaded with other colorants such as, for example, inorganic or organic pigments and/or dyes. They are used in ink sets composed of yellow, magenta, cyan and black inks comprising pigments and/or dyes as colorants. Moreover, they can be used in ink sets which further comprise one or more spot colors, examples being orange, green, blue and/or specialty colors (gold, silver). Preference is given in this context to a set of printing inks whose black preparation preferably comprises carbon black as colorant, more particularly a gas black or furnace black; whose cyan preparation comprises one or more of the pigment preparations of the invention from the group of phthalocyanine pigments, optionally shaded with Pigment Blue 16, Pigment Blue 56, Pigment Blue 60 or Pigment Blue 61; whose magenta preparation preferably comprises a pigment from the group of monoazo, disazo, β-naphthol, naphthol AS, laked azo, metal complex, benzimidazolone, anthanthrone, anthraquinone, quinacridone, dioxazine, perylene, thioindigo, triarylcarbonium or diketopyrrolopyrrole pigments, more particularly the Colour Index pigments Pigment Red 2, Pigment Red 3, Pigment Red 4, Pigment Red 5, Pigment Red 9, Pigment Red 12, Pigment Red 14, Pigment Red 38, Pigment Red 48:2, Pigment Red 48:3, Pigment Red 48:4, Pigment Red 53:1, Pigment Red 57:1, Pigment Red 112, Pigment Red 122, Pigment Red 144, Pigment Red 146, Pigment Red 147, Pigment Red 149, Pigment Red 168, Pigment Red 169, Pigment Red 170, Pigment Red 175, Pigment Red 176, Pigment Red 177, Pigment Red 179, Pigment Red 181, Pigment Red 184, Pigment Red 185, Pigment Red 187, Pigment Red 188, Pigment Red 207, Pigment Red 208, Pigment Red 209, Pigment Red 210, Pigment Red 214, Pigment Red 242, Pigment Red 247, Pigment Red 253, Pigment Red 254, Pigment Red 255, Pigment Red 256, Pigment Red 257, Pigment Red 262, Pigment Red 263, Pigment Red 264, Pigment Red 266, Pigment Red 269, Pigment Red 270, Pigment Red 272, Pigment Red 274, Pigment Violet 19, Pigment Violet 23 or Pigment Violet 32; whose yellow preparation preferably comprises a pigment from the group of monoazo, disazo, benzimidazoline, isoindolinone, isoindoline or perinone pigments, more particularly the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 120, Pigment Yellow 126, Pigment Yellow 127, Pigment Yellow 128, Pigment Yellow 139, Pigment Yellow 150, Pigment Yellow 151, Pigment Yellow 154, Pigment Yellow 155, Pigment Yellow 173, Pigment Yellow 174, Pigment Yellow 175, Pigment Yellow 176, Pigment Yellow 180, Pigment Yellow 181, Pigment Yellow 191, Pigment Yellow 194, Pigment Yellow 196, Pigment Yellow 213 or Pigment Yellow 219; whose orange preparation preferably comprises a pigment from the group of disazo, β-naphthol, naphthol AS, benzimidazolone or perinone pigments, more particularly the Colour Index pigments Pigment Orange 5, Pigment Orange 13, Pigment Orange 34, Pigment Orange 36, Pigment Orange 38, Pigment Orange 43, Pigment Orange 62, Pigment Orange 68, Pigment Orange 70, Pigment Orange 71, Pigment Orange 72, Pigment Orange 73, Pigment Orange 74 or Pigment Orange 81; and whose green preparation preferably comprises a pigment from the group of phthalocyanine pigments, more particularly the Colour Index pigments Pigment Green 7 or Pigment Green 36.

The ink sets may further comprise shading dyes as well, preferably from the group of C.I. Acid Yellow 3, C.I. Food Yellow 3, C.I. Acid Yellow 17 and C.I. Acid Yellow 23; C.I. Direct Yellow 86, C.I. Direct Yellow 28, C.I. Direct Yellow 51, C.I. Direct Yellow 98 and C.I. Direct Yellow 132; C.I. Reactive Yellow 37; C.I. Direct Red 1, C.I. Direct Red 11, C.I. Direct Red 37, C.I. Direct Red 62, al. Direct Red 75, C.I. Direct Red 81, C.I. Direct Red 87, C.I. Direct Red 89, C.I. Direct Red 95 and C.I. Direct Red 227; C.I. Acid Red 1, C.I. Acid Red 8, C.I. Acid Red 18, C.I. Acid Red 52, C.I. Acid Red 80, C.I. Acid Red 81, C.I. Acid Red 82, C.I. Acid Red 87, C.I. Acid Red 94, C.I. Acid Red 115, C.I. Acid Red 131, C.I. Acid Red 144, C.I. Acid Red 152, C.I. Acid Red 154, C.I. Acid Red 186, C.I. Acid Red 245, C.I. Acid Red 249 and C.I. Acid Red 289; C.I. Reactive Red 21, C.I. Reactive Red 22, C.I. Reactive Red 23, C.I. Reactive Red 35, C.I. Reactive Red 63, C.I. Reactive Red 106, C.I. Reactive Red 107, C.I. Reactive Red 112, C.I. Reactive Red 113, C.I. Reactive Red 114, C.I. Reactive Red 126, C.I. Reactive Red 127, C.I. Reactive Red 128, C.I. Reactive Red 129, C.I. Reactive Red 130, C.I. Reactive Red 131, C.I. Reactive Red 137, C.I. Reactive Red 160, C.I. Reactive Red 161, C.I. Reactive Red 174 and C.I. Reactive Red 180, C.I. Acid Violet 48, C.I. Acid Violet 54, C.I. Acid Violet 66, C.I. Acid Violet 126, C.I. Acid Blue 1, C.I. Acid Blue 9, C.I. Acid Blue 80, C.I. Acid Blue 93, C.I. Acid Blue 93:1, C.I. Acid Blue 182, C.I. Direct Blue 86, C.I. Direct Blue 199, C.I. Acid Green 1, C.I. Acid Green 16, C.I. Acid Green 25, C.I. Acid Green 81, C.I. Reactive Green 12, C.I. Acid Brown 126, C.I. Acid Brown 237, C.I. Acid Brown 289, C.I. Acid Black 194, C.I. Sulphur Black 1, C.I. Sulphur Black 2, C.I. Sol. Sulphur Black 1, C.I. Reactive Black 5, C.I. Reactive Black 31, C.I. Reactive Black 8; the reactive dyes may also be present in their partly or wholly hydrolyzed form.

In the examples which follow, parts are parts by weight and percent is percent by weight.

### EXAMPLE 1 (COMPARATIVE)

### Salt Kneading, Phthalimidomethylene-CuPc Dispersant

A 1 l laboratory kneading apparatus (Werner & Pfleiderer) was charged with 75 g of crude copper phthalocyanine (prepared, for example, according to DE-A-2432564, example 1), 375 g of NaCl, 3.75 g of phthalimidomethyl-copper phthalocyanine (prepared as in EP 1 061 419, example 1) and 100 ml of diethylene glycol. The kneading time is 8 h and the kneading temperature is about 95° C. After the end of kneading, the kneaded material is transferred to a 6 l flask and is stirred with 4000 ml of dilute hydrochloric acid (5% by weight) at room temperature for 2 h. Thereafter the suspension is filtered and the presscake is washed with water, dried in a convection oven at 80° C. for 16 h, and pulverized using an IKA mill. This gives 76 g of a copper phthalocyanine preparation having the physical values reported in Table 1.

### EXAMPLE 2 (COMPARATIVE)

### Vibration Milling; CuPc-Sulfoacid Dispersant

In a vibrating mill operating on the centric vibration principle and containing iron rods, crude copper phthalocyanine (prepared as in EP 1 061 419, example 1) is ground. The grinding media charge is 75%. The millbase charge is 80%. Grinding takes place for 90 minutes. The ground material is stirred in 4-times the amount of 5% by weight sulfuric acid at 90° C. for 2 hours, the suspension is filtered with suction and the presscake is washed salt-free. The aqueous presscake has a dry matter content of 33% by weight.

### Subsequent Solvent Treatment

303 g of the presscake thus produced are slurried in 240 g of 53% by weight sodium hydroxide solution and 240 g of isobutanol and then admixed with 3 g of copper phthalocyanine-sulfonic acid (degree of sulfonation approximately 1.5). The mixture is homogenized and stirred under pressure at 135° C. for 3 h. Then the isobutanol is distilled off and the amount of solvent distilled is replaced by water. The suspension is filtered and the presscake is washed to neutrality and dried. This gives 102 g of a copper phthalocyanine preparation having the physical values reported in Table 1.

### EXAMPLE 3

A 1 l laboratory kneading apparatus (Werner & Pfleiderer) is charged with 75 g of crude copper phthalocyanine (prepared, for example, according to DE-A-2432564, example 1), 375 g of NaCl and 100 ml of diethylene glycol. The kneading time is 8 h and the kneading temperature is about 95° C. After the end of kneading, the kneaded material is transferred to a 6 l flask and is stirred with 4000 ml of dilute hydrochloric acid (5% by weight) at room temperature for 2 h. The suspension is then filtered and the presscake is washed with water. The resulting pigment filtercake is slurried in 800 ml of water and stirred with 6.5 g of copper phthalocyanine-sulfonic acid (degree of sulfonation approximately 1.5) and with 1.60 g (0.005 mol) of trimethylcetylammonium chloride at 80° C. for 2 h. The suspension is filtered and the product is washed, dried in a convection oven at 80° C. for 16 h, and pulverized using an IKA mill. This gives 83 g of a copper phthalocyanine preparation having the physical values reported in Table 1.

### EXAMPLE 4

A copper phthalocyanine preparation is produced in the same way as in example 3, with the sole difference that 1.67 g (0.005 mol) of stearyltrimethyl-ammonium chloride are used instead of trimethylcetylammonium chloride.

### EXAMPLE 5

A copper phthalocyanine preparation is produced in the same way as in example 3, with the sole difference that 2.86 g (0.005 mol) of distearyldimethylammonium chloride are used instead of trimethylcetylammonium chloride.

### EXAMPLE 6

A copper phthalocyanine preparation is produced in the same way as in example 3, with the sole difference that 1.63 g (0.005 mol) of stearylbenzyl-dimethylammonium chloride are used instead of trimethylcetylammonium chloride.

TABLE 1

| Sample | d₅₀ [nm] | Length:width | Charge [C/g] |
|---|---|---|---|
| Example 1 (comparative) | 68 | 1.7:1 | −0.9 |
| Example 2 (comparative) | 73 | 2.8:1 | −2.9 |
| Example 3 | 72 | 1.9:1 | −3.0 |
| Example 4 | 70 | 1.9:1 | −3.1 |
| Example 5 | 74 | 1.8:1 | −3.2 |
| Example 6 | 71 | 1.7:1 | −3.0 |

For the particle size distribution a series of electron micrographs is used. The primary particles are identified visually. The area of each primary particle is determined with the aid of a graphics tablet. From the area, the diameter of the circle of equal area is ascertained. The frequency distribution of the equivalent diameters calculated in this way is determined, and the frequencies converted to volume fractions and expressed as a particle size distribution. The d₅₀ value indicates the equivalent diameter for which it is the case that 50% of the particles counted are smaller.

The charge of the pigments is measured in accordance with the method described in “Electrostatics 1999; lnst. Phys. Conf. Ser. No 163, page 285, Streaming Current Charge versus Tribo Charge; R. Baur, H-T. Macholdt, E. Michel”. The result reported is the charge in coulombs/gram of pigment as in Table 1.

### Application Example 1

### Dispersions For UV-Curing Inkjet Inks

With 20 g in each case of pigment preparation from examples 1, 2 and 3, respectively, 78 g of an acrylate oligomer mixture, 1 g of a polymeric dispersing assistant, and 1 g of stabilizer, a concentrate of the pigment is produced and is dispersed by means of a paint shaker.

From the resultant dispersions, a viscosity profile at different shear rates is ascertained.

In the case of the dispersion with the pigment preparation of the invention, according to example 3, a viscosity profile is obtained which has a low initial 10 _{—} viscosity and little change in viscosity as a function of shear (graph 1).

### Application Example 2

### UV-Curing Inkjet Inks

15 g of the concentrate from application example 1 are mixed in each case with 76.6 g of an acrylate monomer, 8 g of a photoinitiator mixture and 0.4 g of a wetting agent, to form an ink.

The inks thus obtained are stored hot at 60° C. The viscosity is determined at the beginning and also after 7, 14, 21 and 28 days.

In the case of the ink with the pigment preparation of the invention, a stable viscosity is obtained which shows no significant change in the course of hot storage (graph 2).

### Application Example 3

### Dispersions For Solvent-Based Inkjet Inks

With 12 g in each case of a pigment preparation according to examples 1, 2 and 3, respectively, 13.2 g of a PVC/PVA copolymer, and 74.8 g of ®Dowanol PMA, a concentrate of the pigment is produced and is dispersed by means of a paint shaker.

From the resultant dispersions, a viscosity profile at different shear rates is ascertained.

In the case of the dispersion with the pigment preparation of the invention, according to example 3, a viscosity profile is obtained which has a low initial viscosity and little change in viscosity as a function of shear (graph 3).

1. A pigment preparation comprising
(a) pigmentary, beta-phase copper phthalocyanine with an average particle size d₅₀ of 40 to 80 nm and an average pigment particle length-to-width ratio of less than or equal to 2.0:1; and
(b) 1% to 30% by weight, based on the weight of the pigmentary copper phthalocyanine, of a pigment dispersant of the formula (II) 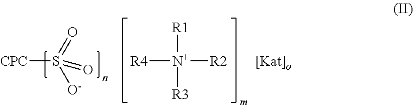
wherein
CPC is a radical of a copper phthalocyanine,
n is a number from 1 to 4.0;
m is a number from 0.5 to 4.0;
Kat is a cation from the group of the alkali metals or H⁺;
o is a number from 0 to 3.5, with n=m+o;
R^{1,} R², R³, and R⁴ are identical or different and are C₁-C₂₀ alkyl, C₂-C₂₀ alkenyl, C₅-C₂₀ cycloalkyl, C₅-C₂₀ cycloalkenyl or C₁-C₄ alkyl-phenyl, the aforesaid radicals being optionally substituted by hydroxyl halogen or both.

2. The pigment preparation as claimed in claim 1, wherein R¹, R², and R³ are C₁-C₄ alkyl, and
R⁴ is C₁₂-C₂₀ alkyl, C₁₂-C₂₀ alkenyl, C₆-C₂₀ cycloalkyl, C₆-C₂₀ cycloalkenyl or benzyl, the aforesaid radicals being optionally substituted by hydroxyl, halogen or both.

3. The pigment preparation as claimed in claim 1, wherein
R¹ and R² are C₁-C₄ alkyl, and
R³ and R⁴ are C₆-C₂₀ alkyl, C₆-C₂₀ alkenyl, C₆-C₂₀ cycloalkyl, C₆-C₂₀ cycloalkenyl or benzyl, the aforesaid radicals being optionally substituted by hydroxyl, halogen or both.

4. The pigment preparation as claimed in claim 1, wherein
R¹, R², and R³ are methyl, and
R⁴ is C₁₄-C₂₀ alkyl or C₁₄-C₂₀ alkenyl.

5. The pigment preparation as claimed in claim 1, wherein the average particle size d₅₀ is 50 to 75 nm.

6. The pigment preparation as claimed in claim 1, wherein the average pigment particle length-to-width ratio is 1.6:1 to 1.9:1.

7. The pigment preparation as claimed in claim 1, comprising 5% to 20% by weight, based on the weight of the pigmentary copper phthalocyanine, of a the pigment dispersant of the formula (II).

8. A method of producing a pigment preparation as claimed in claim 1, comprising the steps of subjecting a crude copper phthalocyanine pigment to salt kneading with a crystalline inorganic salt in the presence of an organic solvent, and, adding a pigment dispersant of the formula (II) one or more times before, during or after the salt kneading.

9. A pigmented inkjet ink, electrophotographic toner, electrophotographic developer or color filter pigmented by a pigment preparation as claimed in claim 1.

10. A pigmented solvent-based inkjet ink or UV-curing inkjet ink pigmented by the pigmented inkjet ink, electrophotographic toner, electrophotographic developer or color filter as claim in claim 9.
